(19) United States
(12) Patent Application Publication
(10) Pub. No.: US 2026/0011124 A1
(43) Pub. Date: Jan. 8, 2026

(54) DATA OBTAINING DEVICE, DATA OBTAINING METHOD, AND DATA OBTAINING STAGE

(71) Applicant: KYOCERA Corporation, Kyoto-shi, Kyoto (JP)

(72) Inventors: Minami ASATANI, Asaka-shi, Saitama (JP); Kazuhisa ARAKAWA, Yokohama-shi, Kanagawa (JP)

(21) Appl. No.: 18/869,269

(22) PCT Filed: May 18, 2023
(86) PCT No.: PCT/JP2023/018642

§ 371 Date: Nov. 25, 2024

(30) Foreign Application Priority Data
May 31, 2022 (JP) 2022-088692

(51) Int. Cl. G06V 10/774; G06V 10/141; G06V 10/26; G06V 10/82

(52) U.S. Cl. CPC G06V 10/774; G06V 10/141; G06V 10/26; G06V 10/82; G06V 2201/07

(57) ABSTRACT

A data obtaining device includes a controller capable of controlling a display device including a plurality of pixels, each of which is set to either an ON state or an OFF state, and capable of obtaining a captured image, which is obtained by capturing an image of a target located in front of the display device and the display device. The controller sets a state of each pixel to either the ON state or the OFF state in such a way as to increase a number of ON pixels and decrease a number of ON pixels shown in the captured image or decrease a number of OFF pixels and increase a number of OFF pixels shown in the captured image. The controller generates mask data for the target on a basis of arrangement of the ON pixels.

### CROSS-REFERENCE TO RELATED APPLICATIONS

The present application claims priority to Japanese Patent Application No. 2022-88692 filed in the Japan Patent Office on May 31, 2022, the entire contents of which are incorporated herein by reference.

### TECHNICAL FIELD

The present disclosure relates to a data obtaining device, a data obtaining method, and a data obtaining stage.

### BACKGROUND OF INVENTION

Systems that generate learning data to be used for learning in semantic segmentation or the like are known (e.g., see Patent Literature 1).

### CITATION LIST

### Patent Literature

Patent Literature 1: Japanese Unexamined Patent Application Publication No. 2020-102041

### SUMMARY

In an embodiment of the present disclosure, a data obtaining device includes a controller capable of controlling a display device including a plurality of pixels, each of which is set to either an ON state or an OFF state, and capable of obtaining a captured image, which is obtained by capturing an image of a target located in front of the display device and the display device. The controller sets a state of each pixel to either the ON state or the OFF state in such a way as to increase a number of ON pixels and decrease a number of ON pixels shown in the captured image or decrease a number of OFF pixels and increase a number of OFF pixels shown in the captured image. The controller generates mask data for the target on a basis of arrangement of the ON pixels.

In an embodiment of the present disclosure, a data obtaining method includes setting, in a display device including a plurality of pixels, each of which is set to either an ON state or an OFF state, a state of each pixel to either the ON state or the OFF state in such a way as to increase a number of ON pixels and decrease a number of ON pixels shown in a captured image, which is obtained by capturing an image of a target located in front of the display device and the display device, or decrease a number of OFF pixels and increase a number of OFF pixels shown in the captured image and generating mask data for the target on a basis of arrangement of the ON pixels.

In an embodiment of the present disclosure, a data obtaining stage includes a display device including a plurality of pixels and a light transmission member located between a target located in front of the display device and the display device.

### BRIEF DESCRIPTION OF THE DRAWINGS

FIG. 1 is a block diagram illustrating an example of configuration of a data obtaining system according to an embodiment.

FIG. 2 is a plan view illustrating an example of the configuration of the data obtaining system.

FIG. 3 is a cross-sectional view taken along A-A in FIG. 2.

FIG. 4A is a diagram illustrating an example of luminance of each of pixels of a captured image of a target.

FIG. 4B is a diagram illustrating an example of a mask image generated on the basis of the captured image in FIG. 4A.

FIG. 5 is a plan view illustrating an example of a target located on an illumination panel.

FIG. 6 is a diagram illustrating an example of an illumination panel including an ON range and an OFF range.

FIG. 7A is a diagram illustrating an example of an illumination panel that includes pixels in an ON range and pixels in an OFF range and that is controlled in such a way as to extend the ON range.

FIG. 7B is a diagram illustrating an example of an illumination panel that includes pixels in an ON range and pixels in an OFF range and that is controlled in such a way as to reduce the ON range.

FIG. 8 is a diagram illustrating an example of an illumination panel in which a range where the target is located and the ON range match.

FIG. 9 is a perspective view of the illumination panel at a time when the target is assumed to have been moved in a normal direction of the illumination panel in FIG. 8.

FIG. 10A is a diagram illustrating an example of a captured image of the target located on the illumination panel that has been turned off.

FIG. 10B is a diagram illustrating an example of a mask image.

FIG. 10C is a diagram illustrating an example of an extracted image, which is obtained by extracting an image of the target by applying the mask image in FIG. 10B to the captured image in FIG. 10A.

FIG. 11 is a diagram illustrating an example of training data generated by superimposing the extracted image in FIG. 10C upon a background image.

FIG. 12 is a flowchart illustrating an example of a procedure of a data obtaining method.

FIG. 13 is a flowchart illustrating an example of a procedure for determining an ON range.

FIG. 14 is a diagram illustrating an example of extending an ON range in one direction.

FIG. 15 is a diagram illustrating an example of movement of a belt-shaped ON range.

FIG. 16 is a diagram illustrating an example where sections of the illumination panel are sequentially turned on in a certain pattern.

FIG. 17 is a schematic diagram illustrating an example of configuration of a robot control system.

### DESCRIPTION OF EMBODIMENTS

### (Example of Configuration of Data Obtaining System 1)

In an embodiment of the present disclosure, a data obtaining system 1 obtains training data for generating a trained model that outputs a result of recognition of a recognition target included in input information. The trained model may include a CNN (convolution neural network) including a plurality of layers. Convolution based on a certain weighting coefficient is performed on the information input to the trained model in each layer of the CNN. In the training of the trained model, the weighting coefficient is updated. The trained model may include a fully connected layer. The trained model may be VGG16 or ResNet50. The trained model may be a transformer. The trained model is not limited to these examples, and may be a model of one of various other types, instead.

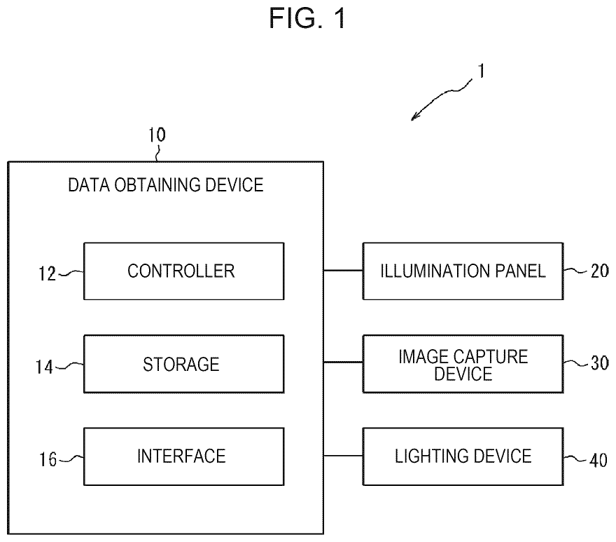

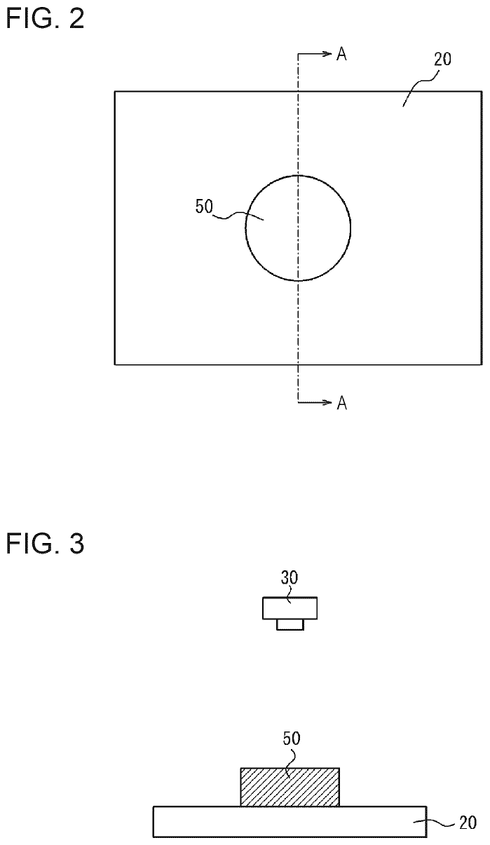

As illustrated in FIGS. 1, 2 and 3, in the embodiment of the present disclosure, the data obtaining system 1 includes a data obtaining device 10, an illumination panel 20, and an image capture device 30. The illumination panel 20 includes an illumination surface, and a target 50 from which training data is to be obtained can be disposed on the illumination surface. The image capture device 30 captures an image of the target 50 disposed on the illumination panel 20 and the illumination panel 20. The data obtaining device 10 controls an illumination state of the illumination panel 20. The data obtaining device 10 obtains an image of the illumination panel 20 and the target 50 captured by the image capture device 30. The image of the illumination panel 20 and the target 50 will also be referred to as a captured image. The data obtaining device 10 is capable of obtaining a captured image. The data obtaining device 10 generates training data for the target 50 on the basis of a captured image and the illumination state of the illumination panel 20 at a time when the captured image has been obtained to obtain the training data.

### <Data Obtaining Device 10>

The data obtaining device 10 includes a controller 12, a storage 14, and an interface 16.

The controller 12 may include at least one processor in order to provide control and processing performance for executing various functions. The processor may execute a program for achieving the various functions of the controller 12. The processor may be achieved as a single integrated circuit. The integrated circuit will also be referred to as an IC. The processor may be achieved as a plurality of integrated circuits and discrete circuits communicably connected to one another. The processor may be achieved on the basis of one of various other known techniques.

The storage 14 may include an electromagnetic storage medium such as a magnetic disk or may include a memory such as a semiconductor memory or a magnetic memory. The storage 14 stores various types of information. The storage 14 stores programs and the like to be executed by the controller 12. The storage 14 may be a non-transitory readable medium. The storage 14 may function as a work memory of the controller 12. At least a part of the storage 14 may be separately configured from the controller 12.

The interface 16 inputs and outputs information or data between the illumination panel 20 and the image capture device 30. The interface 16 may include a communication device capable of wired or wireless communication. The communication device may be capable of performing communication using a communication method based on one of various communication standards. The interface 16 may be achieved by a known communication technique.

The interface 16 may include a display device. The display device may include one of various displays including, for example, a liquid crystal display. The interface 16 may include a sound output device such as a speaker. The interface 16 is not limited to these, and may include one of various other output devices.

The interface 16 may include an input device that receives an input from a user. The input device may include, for example, a keyboard or physical keys or may include a touch panel or a pointing device such as a touch sensor or a mouse. The input device is not limited to these examples, and may include one of various other devices.

### <Illumination Panel 20>

The illumination panel 20 includes the illumination surface. The illumination panel 20 includes a plurality of pixels arranged on the illumination surface. The illumination panel 20 may be capable of setting a state of each pixel to an ON state or an OFF state. Each pixel of the illumination panel 20 may be configured as a spontaneous light emitting element. A shutter that opens and closes and a backlight may be combined together for each pixel of the illumination panel 20, and the pixel may enter the ON state when the shutter is open and the OFF state when the shutter is closed. The illumination panel 20 may be, for example, one of various display devices including a liquid crystal panel and an organic EL (electro-luminescence) or inorganic EL panel.

### <Image Capture Device 30>

The image capture device 30 may include one of various imaging elements, cameras, or the like. The image capture device 30 is disposed in such a way as to be able to capture an image of the illumination surface of the illumination panel 20 and the target 50 disposed on the illumination surface. That is, the image capture device 30 is capable of capturing an image of, along with the illumination panel 20, the target 50 located in front of the illumination panel 20 when viewed from the image capture device 30. The image capture device 30 may be capable of capturing images of the illumination surface of the illumination panel 20 from various directions. The image capture device 30 may be disposed such that a normal direction of the illumination surface of the illumination panel 20 and an optical axis of the image capture device 30 match.

The data obtaining system 1 may also include a darkroom storing the illumination panel 20 and the image capture device 30. When the illumination panel 20 and the image capture device 30 are stored in a darkroom, a side of the target 50 facing the image capture device 30 is not irradiated with ambient light. When the side of the target 50 facing the image capture device 30 is not irradiated with ambient light, an image of the target 50 captured by the image capture device 30 is black or a color close to black. When, among the pixels of the illumination panel 20, pixels in a range larger than a range where the target 50 exists turn on, an image of the target 50 captured by the image capture device 30 shows a silhouette of the target 50.

The data obtaining system 1 may also include a lighting device 40 that emits illumination light that illuminates the target 50. The lighting device 40 may be capable of emitting illumination light in one of various colors. When the data obtaining system 1 includes the lighting device 40, the image capture device 30 may capture an image of the target 50 with the target 50 illuminated by the illumination light and ambient light. When the data obtaining system 1 includes the lighting device 40 and the darkroom, the image capture device 30 may capture an image of the target 50 with the target 50 illuminated by the illumination light. When the data obtaining system 1 does not include the lighting device 40, the image capture device 30 may capture an image of the target 50 with the target 50 illuminated by ambient light.

### (Example of Operation of Data Obtaining System 1)

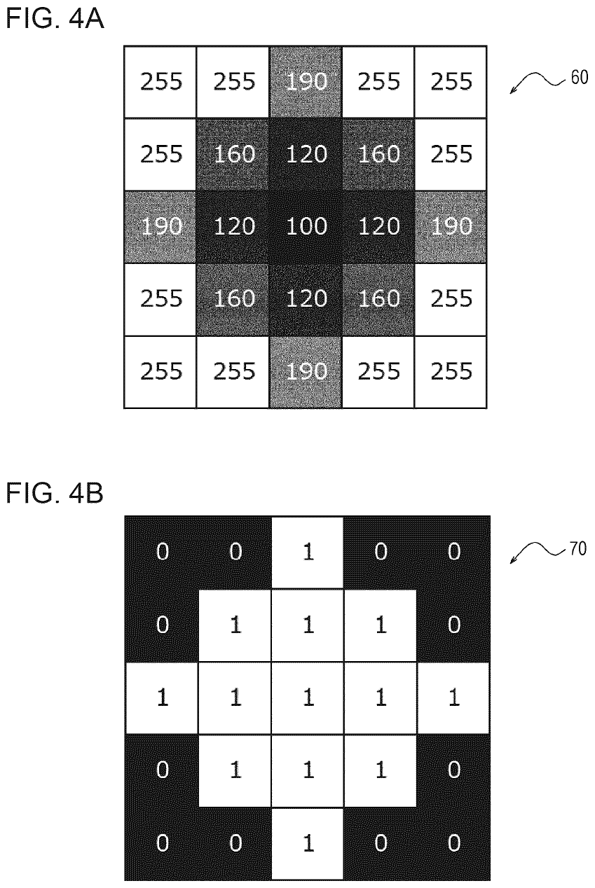

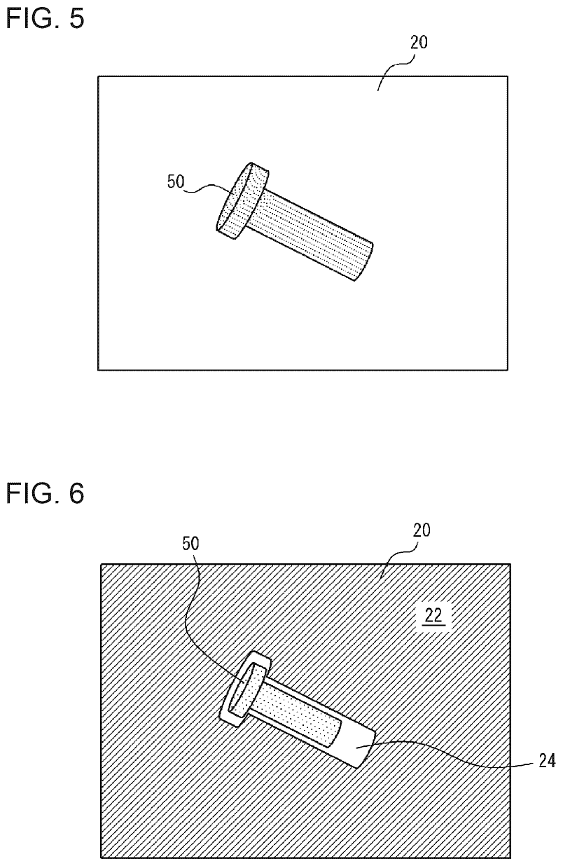

In the data obtaining system 1, the data obtaining device 10 obtains training data to be used in learning for generating a trained model for recognizing the target 50 from an image of the target 50. The image of the target 50 includes a background of the target 50. As illustrated in FIG. 4A, for example, the controller 12 of the data obtaining device 10 may extract an image of the target 50 from a captured image 60 including 25 pixels arranged in a 5-by-5 matrix to obtain training data. A value in a cell corresponding to each pixel corresponds to luminance of the pixel at a time when a color of the pixel is expressed in grayscale. The value indicates luminance in 256 steps of 0 to 255. The larger the value, the whiter the pixel. When the value is 0, the color of the pixel corresponding to the cell is black. When the value is 255, the color of the pixel corresponding to the cell is white.

In FIG. 4A, pixels corresponding to 12 cells whose values are 255 are a background. Pixels corresponding to 13 cells whose values are 190, 160, 120, or 100 are pixels showing the target 50. The controller 12 may generate a mask image 70 as illustrated in FIG. 4B in order to extract the image of the target 50 from the captured image 60. A value in each of cells of the mask image 70 indicates a distinction between a mask section and a transmission section. Pixels corresponding to cells whose values are 1 correspond to a transmission section. The transmission section corresponds to pixels extracted from the captured image 60 as the image of the target 50 when the mask image 70 is superimposed upon the captured image 60. Pixels corresponding to cells whose values are 0 correspond to the mask section. The mask section corresponds to pixels that are not extracted from the captured image 60 when the mask image 70 is superimposed upon the captured image 60. The mask image 70 is used as mask data for extracting the image of the target 50 from the captured image 60.

In a comparative example, whether each pixel of a captured image is a pixel showing a target or a pixel showing a background is determined on the basis of luminance of the pixel. If the luminance of each pixel of the captured image is higher than or equal to a threshold in this case, the pixel is determined as a pixel showing the background. If the luminance of each pixel of the captured image is lower than the threshold, the pixel is determined as a pixel showing the target. In the comparative example, when the background is close to black, a pixel showing the target and a pixel showing the background are difficult to distinguish from each other. Even when each pixel is determined to be showing the background on the basis of a low luminance of the pixel, a pixel showing the target and a pixel showing the background are difficult to distinguish from each other if luminance of pixels showing the background and luminance of pixels showing the target are close to each other. As a result, a transmission section of a mask image is unlikely to match a shape of an image of a target. That is, accuracy of extracting an image of a target is low.

In the present embodiment, therefore, the data obtaining device 10 generates the mask image 70 of the target 50 as mask data for extracting an image of the target 50 on the basis of the image of the target 50 and the state of each pixel of the illumination panel 20 at a time when the image has been captured. More specifically, when, among the pixels of the illumination panel 20, only pixels located behind the target 50 when viewed from the image capture device 30 have turned on, a range of the ON pixels matches a range where the target 50 is located. By generating mask data on the basis of the range of the ON pixels, the transmission section of the mask image 70 used to extract the image of the target 50 tends to match a shape of the image of the target 50. As a result, the accuracy of extracting the image of the target 50 increases.

In other words, the controller 12 of the data obtaining device 10 is capable of controlling a display device including a plurality of pixels, each of which is set to either the ON state or the OFF state, and capable of obtaining the captured image 60 of the target 50 located in front of the display device and the display device. The controller 12 sets the state of each pixel to either the ON state or the OFF state in such a way as to increase the number of ON pixels and decrease the number of ON pixels shown in the captured image 60, and generates mask data for the target 50 on the basis of arrangement of the ON pixels.

A specific example of the operation of the data obtaining system 1 will be described hereinafter.

The controller 12 of the data obtaining device 10 obtains training data for generating a trained model that recognizes the target 50. As illustrated in FIG. 5, in order to obtain the training data for the target 50, the target 50 is disposed on the illumination panel 20. The target 50 illustrated in FIG. 5 is a bolt-like part. The target 50 is not limited to a bolt and may be one of various other parts, and is not limited to a part and may be one of various other articles, instead.

As illustrated in FIG. 6, the controller 12 determines initial arrangement of ON pixels such that a shape of an ON range 24 of the illumination panel 20 viewed from the image capture device 30 becomes close to a shape of the target 50. An initial setting of the ON range 24 will also be referred to as an initial ON range. The controller 12 may set the initial ON range by recognizing the shape of the target 50 from an image captured with the target 50 disposed on the illumination panel 20. The controller 12 may set the initial ON range using one of various other methods.

The controller 12 may determine ON pixels such that the ON range 24 of the illumination panel 20 becomes larger than the target 50. That is, the controller 12 may determine ON pixels such that a part of the ON range 24 of the illumination panel 20 becomes visible from the image capture device 30. When the ON range 24 is larger than the target 50, the controller 12 may make the ON range 24 close to the shape of the target 50 by narrowing the ON range 24 (extending an OFF range 22 inward) in the image captured by the image capture device 30 on the basis of the image.

The controller 12 may determine ON pixels such that the ON range 24 of the illumination panel 20 becomes smaller than the target 50. That is, the controller 12 may determine ON pixels such that the ON range 24 of the illumination panel 20 becomes invisible from the image capture device 30. When the ON range 24 is smaller than the target 50, the controller 12 may make the ON range 24 close to the shape of the target 50 by extending the ON range 24 outward until the image captured by the image capture device 30 shows the ON range 24 and then narrowing the ON range 24 (extending the OFF range 22 inward) on the basis of the image.

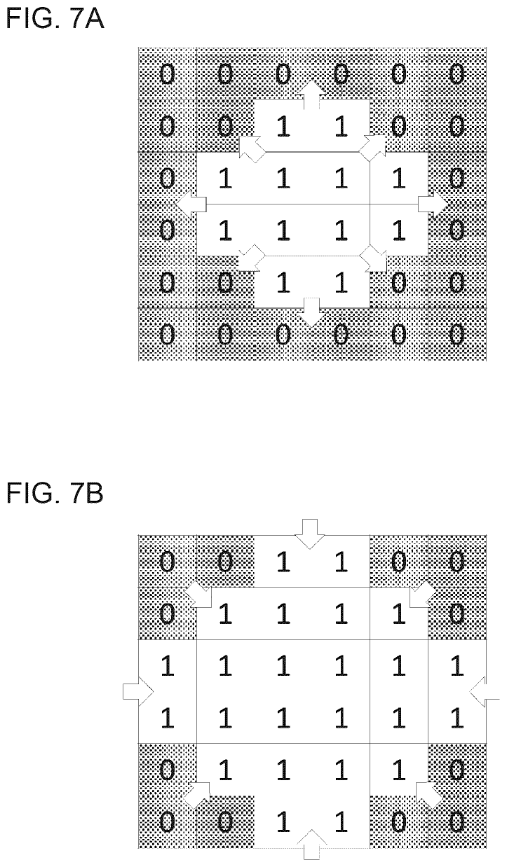

When extending the ON range 24, the controller 12 may expand, as illustrated in FIG. 7A, cells with “1”, which indicates the transmission section located in an inner part of the mask image 70, toward cells with “0”, which indicates the mask section located in an outer part of the mask image 70, through morphological processing. Alternatively, when expanding the ON range 24, the controller 12 may contract, as illustrated in FIG. 7B, the cells with “0”, which indicates the mask section located in the outer part of the mask image 70, toward the cells with “1”, which indicates the transmission section located in the inner part of the mask image 70, through morphological processing.

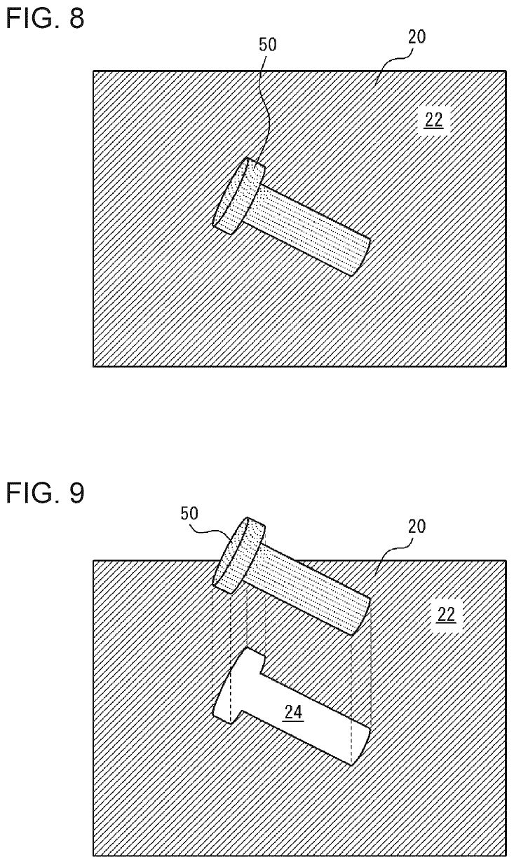

As illustrated in FIG. 8, the controller 12 controls the ON range 24 such that the ON range 24 becomes invisible from the image capture device 30 and only the target 50 and the OFF range 22 become visible to the image capture device 30. As illustrated in FIG. 9, the controller 12 then maximizes the ON range 24 of pixels located behind the target 50 when viewed from the image capture device 30. That is, the controller 12 sets the state of each pixel to either the ON state or the OFF state in such a way as to increase the number of ON pixels and decrease the number of ON pixels shown in the captured image 60. As illustrated in FIGS. 8 and 9, the controller 12 can make the shape of the ON range 24 close to the shape of the target 50 by controlling the state of each pixel as described above.

The controller 12 may generate mask data on the basis of arrangement of ON pixels included in the ON range 24 at a time when the ON range 24 has been maximized and the ON range 24 shown in the captured image 60 has been minimized. The controller 12 may determine that the ON range 24 has been maximized and the ON range 24 shown in the captured image 60 has been minimized if a difference between the number of ON pixels at a time when a part of the ON range 24 is shown in the captured image 60 and the number of ON pixels at a time when the ON range 24 is not shown in the captured image 60 at all is smaller than or equal to a certain value.

The controller 12 can finalize the setting of the ON range 24 by repeating the procedure of extending and reducing the ON range 24. The controller 12 may determine that the setting of the ON range 24 has been finalized when the number of times of extension and reduction of the ON range 24 becomes larger than or equal to a certain value. In other words, the controller 12 may determine that the setting of the ON range 24 has been finalized if the number of times of extension and reduction of the ON range 24 becomes larger than or equal to a determination threshold.

The controller 12 may determine whether a switch between a state where the captured image 60 shows ON pixels and a state where the captured image 60 does not show ON pixels occurs by extending or contracting pixels located at a contour of the target 50 by one pixel. If the ON range 24 has been set such that a switch between the state where the captured image 60 shows ON pixels and the state where the captured image 60 does not show ON pixels occurs by extending or contracting all pixels located at the contour of the target 50 by one pixel, the controller 12 may determine that the setting of the ON range 24 has been finalized.

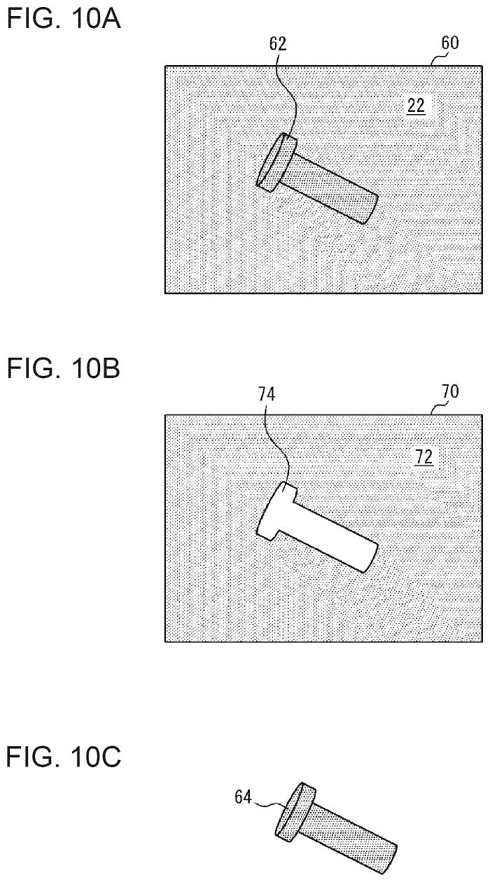

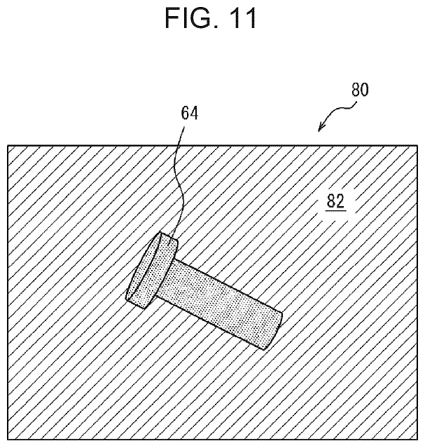

The controller 12 extracts a target image 62 from the captured image 60 using the generated mask image 70 to generate an extracted image 64 (see FIG. 10C). More specifically, the controller 12 obtains the captured image 60 illustrated in FIG. 10A, the captured image 60 being obtained with the illumination panel 20 turned off and the target 50 disposed on the illumination panel 20. The captured image 60 in FIG. 10A includes the target image 62 obtained by capturing an image of the target 50 as a foreground and the OFF range 22, in which the illumination panel 20 is off, as a background.

The controller 12 may generate the extracted image 64 by extracting image data regarding the target 50 from the captured image 60 used to generate the mask data. The controller 12 may generate the extracted image 64 by extracting, on the basis of the mask data for the target 50, the image data regarding the target 50 from an image of the target 50 captured at the same position as when the captured image 60 has been captured.

The controller 12 generates the extracted image 64 illustrated in FIG. 10C by extracting the target image 62 while applying the mask image 70 illustrated in FIG. 10B to the captured image 60 illustrated in FIG. 10A. The mask image 70 includes a mask section 72 and a transmission section 74. A part of the captured image 60 corresponding to the transmission section 74 is extracted as the target image 62. The extracted image 64 includes a foreground including pixels showing the target 50 and a background consisting of transparent pixels.

The controller 12 may generate training data using the extracted image 64. More specifically, the controller 12 may generate, as illustrated in FIG. 11, an image obtained by combining together the extracted image 64 and any background image 82 as a composite image 80. The controller 12 may output the composite image 80 as the training data.

### <Example of Procedure of Data Obtaining Method>

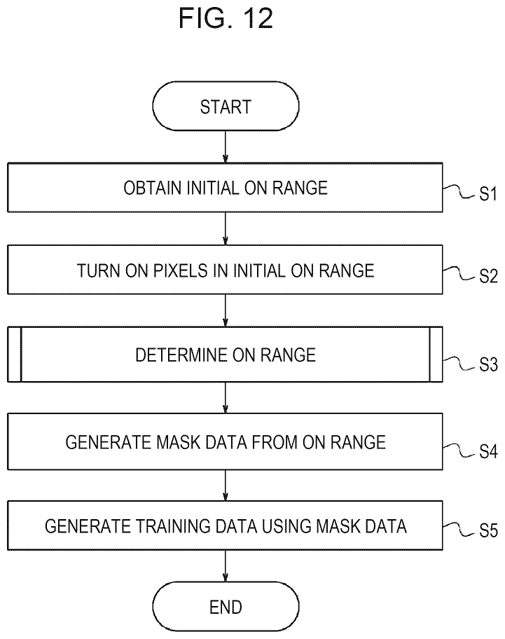

The data obtaining device 10 may perform a data obtaining method including a procedure illustrated in a flowchart of FIG. 12. The data obtaining method may be achieved as a data obtaining program executed by the processor included in the controller 12 of the data obtaining device 10, instead. The data obtaining program may be stored in a non-transitory computer-readable medium.

The controller 12 obtains an initial ON range corresponding to a state where the target 50 is disposed on the illumination panel 20 (step S1). The controller 12 turns on pixels in the initial ON range of the illumination panel 20 (step S2).

The controller 12 determines, on the basis of the captured image 60 captured by the image capture device 30, the ON range 24 in such a way as to increase the number of ON pixels of the illumination panel 20 and decrease the number of ON pixels shown in the captured image 60 (step S3). The controller 12 determines the ON range 24 as arrangement of ON pixels of the illumination panel 20.

The controller 12 generates mask data from the determined ON range 24 (step S4). More specifically, the controller 12 determines, in the mask data, pixels corresponding positions of ON pixels of the illumination panel 20 as a transmission section and pixels corresponding to positions of OFF pixels of the illumination panel 20 as a mask section.

The controller 12 extracts an image of the target 50 from the captured image 60 using the mask data to generate training data (step S5). After performing the procedure in step S5, the controller 12 ends the execution of the procedure illustrated in the flowchart of FIG. 12.

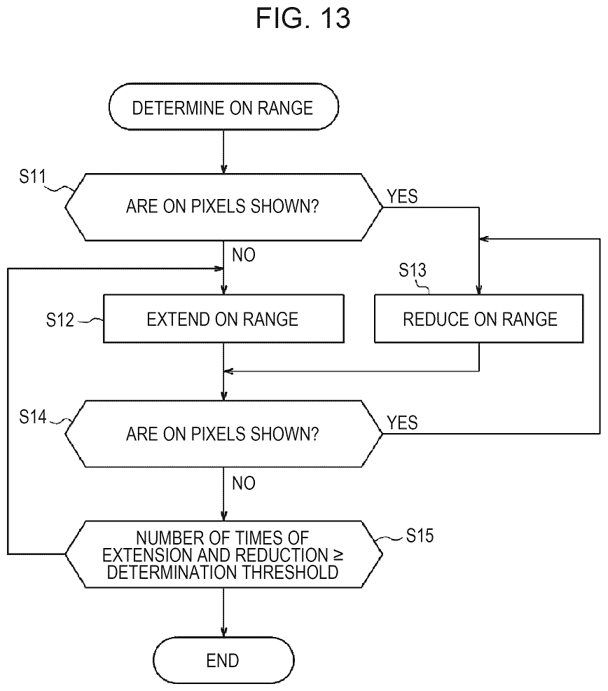

The controller 12 may perform a procedure illustrated in a flowchart of FIG. 13 as the procedure for determining the ON range 24 in step S3 in FIG. 12.

The controller 12 determines whether the captured image 60 shows ON pixels (step S11). If the captured image 60 does not show ON pixels (step S11: NO), the controller 12 extends the ON range 24 in consideration of a possibility that pixels located behind the target 50 include OFF pixels (step S12). If the captured image 60 shows ON pixels (step S11: YES), the controller 12 reduces the ON range 24 in such a way as to decrease the number of ON pixels (step S13). After performing step S12 or S13, the controller 12 proceeds to a procedure in step S14.

The controller 12 again determines whether the captured image 60 shows ON pixels (step S14). If the captured image 60 shows ON pixels (step S14: YES), the controller 12 returns to the procedure in step S13 and further reduces the ON range 24. If the captured image 60 does not show ON pixels (step S14: NO), the controller 12 determines whether the number of times of extension and reduction of the ON range 24 in steps S12 and S13 is larger than or equal to the determination threshold (step S15). If the number of times is not larger than or equal to the determination threshold (step S15: NO), that is, if the number of times is smaller than the determination threshold, the controller 12 may estimate that the pixels located behind the target 50 are likely to include OFF pixels and return to the procedure for extending the ON range 24 in step S12. If the number of times is larger than or equal to the determination threshold (step S15: YES), the controller 12 may estimate that the pixels located behind the target 50 are unlikely to include OFF pixels, ends the execution of the procedure illustrated in the flowchart of FIG. 13, and determines the ON range 24.

The controller 12 may determine, in the determination procedure in step S15, whether a difference between the number of ON pixels at a time when the captured image 60 shows ON pixels and the number of ON pixels at a time when the captured image 60 does not show ON pixels at all is smaller than the certain value. If the difference between the number of ON pixels at a time when the captured image 60 shows ON pixels and the number of ON pixels at a time when the captured image 60 does not show ON pixels at all is smaller than the certain value, the controller 12 may determine that the ON range 24 has been maximized and the ON range 24 shown in the captured image 60 has been minimized.

### Summary

As described above, with the data obtaining system 1, the data obtaining device 10, and the data obtaining method according to the present embodiment, the number of ON pixels is increased among the pixels located behind the target 50 without showing ON pixels in the captured image 60. In doing so, an ON range 24 that matches the shape of the target 50 is set. By generating mask data for the target 50 on the basis of the set ON range 24, accuracy of the mask data can be increased. Since the mask data is accurately generated, the image of the target 50 need not be manually corrected. As a result, annotations can be simplified.

### Other Embodiments

Other embodiments will be described hereinafter.

### <Example of Generation of Mask Data>

The controller 12 may set, for each pixel included in mask data, data indicating that the target 50 is present at a position of the pixel as a part of a mask section. The controller 12 may set, for each pixel included in the mask data, data indicating that the target 50 is absent at the position of the pixel as a part of a transmission section.

If a part of the captured image 60 corresponding to a certain pixel of the illumination panel 20 does not change as a result of a switch of a state of the certain pixel of the illumination panel 20 to the ON state or the OFF state, the controller 12 may set data indicating that the target 50 is present at a pixel in the mask data corresponding to the certain pixel of the illumination panel 20.

If a part of the captured image 60 corresponding to a certain pixel of the illumination panel 20 changes as a result of a switch of a state of the certain pixel of the illumination panel 20 to the ON state or the OFF state, the controller 12 may set data indicating that the target 50 is absent at a pixel in the mask data corresponding to the certain pixel of the illumination panel 20.

In doing so, the mask data can be accurately generated.

The controller 12 may perform calibration for associating a position of each pixel of the display device such as the illumination panel 20 and a position of each pixel of the captured image 60. In doing so, the accuracy of the mask data can be increased.

The controller 12 may change the ON range 24 of the illumination panel 20 in various patterns in order to identify pixels located behind the target 50. The controller 12 may change a state of a certain pixel by performing expansion or contraction on the basis of arrangement of pixels of the illumination panel 20 in the ON state and the OFF state.

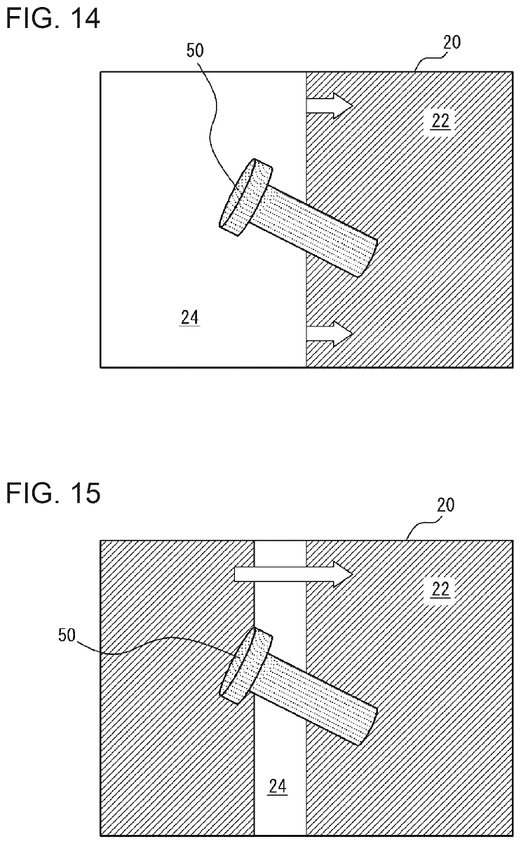

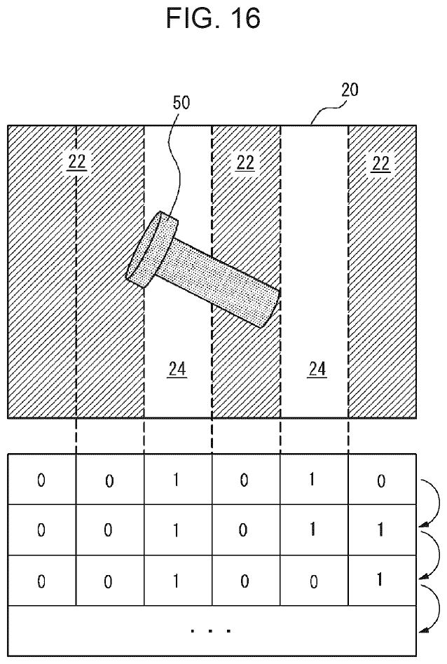

The controller 12 may collectively change states of a plurality of pixels as certain pixels of the illumination panel 20 whose states are to be changed as described above. As illustrated in FIG. 14, the controller 12 may control the state of each pixel of the illumination panel 20 in such a way as to extend the ON range 24 in a certain direction such as vertically or horizontally. As illustrated in FIG. 15, the controller 12 may control the state of each pixel of the illumination panel 20 in such a way as to move a belt-shaped ON range 24. In this case, the pixels of the illumination panel 20 turn on or off in units of a vertical or horizontal line.

Each time the controller 12 changes the ON range 24 of the illumination panel 20, the controller 12 may identify a range where the captured image 60 shows ON pixels. The controller 12 may determine, on the basis of the range where the captured image 60 shows ON pixels identified for the ON range 24 after each change, the ON range 24 in such a way as to maximize the number of ON pixels and minimize the number of ON pixels shown in the captured image 60.

In doing so, an effect of light emitted from pixels in adjacent or nearby lines is reduced. As a result, accuracy of determining whether the captured image 60 shows ON pixels can be increased. A line for collectively controlling turning on and off is not limited to a vertical or horizontal line, and may be an oblique line, instead. The number of lines for collectively controlling turning on and off may be one, or two or more. In other words, the controller 12 may collectively change states of at least a plurality of pixels arranged in a line as certain pixels of the illumination panel 20.

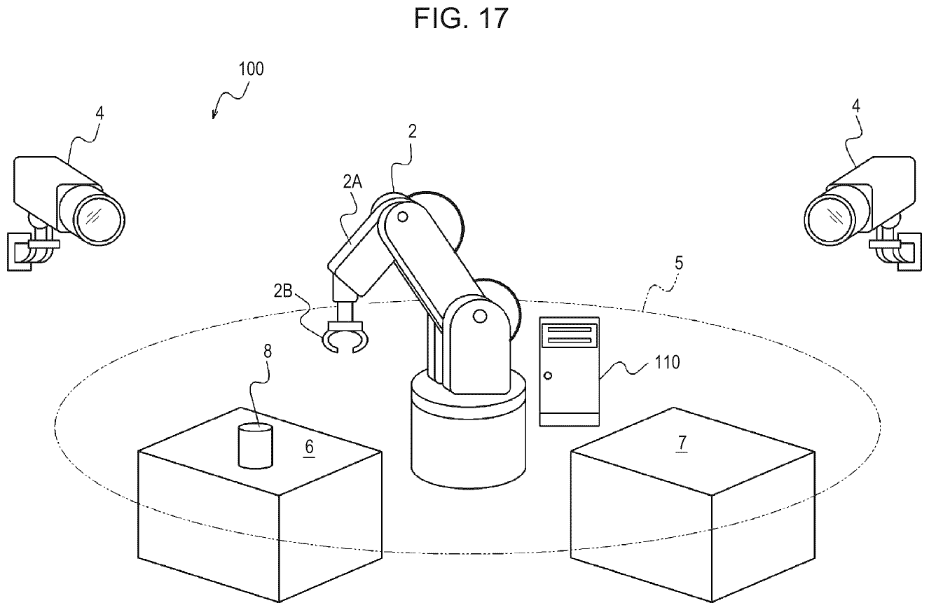

As illustrated in FIG. 16, the controller 12 may divide the illumination panel 20 into a plurality of sections and control the state of each pixel of the illumination panel 20 in such a way as to change a pattern of combination of turning on and off in each section. In FIG. 16, the controller 12 divides the illumination panel 20 into six sections and sets each section as an ON range 24 or an OFF range 22. In other words, the controller 12 may collectively change the state of each of the plurality of pixels included in a certain block as certain pixels of the illumination panel 20.

A table shown in FIG. 16 below the illumination panel 20 indicates a pattern of combination of states of sections as a combination of 0s and 1s. The ON range 24 corresponds to a cell with 1. The OFF range 22 corresponds to a cell with 0. The state of the illumination panel 20 illustrated in FIG. 16 is expressed as “001010” shown in a top row of the table.

The controller 12 may sequentially change the combination of the states of the sections of the illumination panel 20 as indicated in the table. The controller 12 may identify a range where the captured image 60 shows ON pixels in each combination of the states of the illumination panel 20. The controller 12 may determine, on the basis of the range where the captured image 60 shows ON pixels identified for each combination, the ON range 24 in such a way as to maximize the number of ON pixels and minimize the number of ON pixels shown in the captured image 60.

In doing so, the controller 12 can determine presence or absence of an effect of light emitted from pixels in adjacent or nearby lines. As a result, the accuracy of determining whether the captured image 60 shows ON pixels can be increased.

In the above-described embodiment, the controller 12 generates mask data for the target 50 by setting the state of each pixel to either the ON state or the OFF state in such a way as to increase the number of ON pixels and decrease the number of ON pixels shown in the captured image 60. Conversely, the controller 12 may set the state of each pixel to either the ON state or the OFF state in such a way as to decrease the number of OFF pixels and increase the number of OFF pixels shown in the captured image 60. In the procedure of step S3 in FIG. 12, for example, the controller 12 may determine, on the basis of the captured image 60, the OFF range 22 in such a way as to decrease the number of OFF pixels and increase the number of OFF pixels shown in the captured image 60 instead of determining the ON range 24 in such a way as to increase the number of ON pixels and decrease the number of ON pixels shown in the captured image 60.

When controlling the state of each pixel on the basis of the number of OFF pixels, the controller 12 may determine whether each pixel of the captured image 60 shows the target 50 or is an OFF pixel. The controller 12 may distinguish the target 50 and an OFF pixel through, for example, image processing performed on the captured image 60. The controller 12 may use a trained model for distinguishing the target 50 and an OFF pixel. The controller 12 may control lighting for the target 50 by the lighting device 40, which will be described later, such that a difference between luminance of pixels of the captured image 60 showing the target 50 and luminance of pixels that are OFF pixels.

### <Data Obtaining Stage>

The data obtaining system 1 may include a data obtaining stage for obtaining data. The data obtaining stage may include the illumination panel 20 and a plate for disposing the target 50 on the illumination surface of the illumination panel 20. The plate for disposing the target 50 transmits light emitted from the illumination panel 20, and will also be referred to as a light transmission member. The light transmission member may be configured such that the target 50 does not directly come into contact with the illumination surface. The light transmission member may be provided away from the illumination surface or may be provided on the illumination surface.

The data obtaining stage may also include a darkroom for storing the illumination panel 20 and the light transmission member. The data obtaining stage may also include the lighting device 40 capable of illuminating the target 50.

### (Example of Configuration of Robot Control System 100)

As illustrated in FIG. 17, in an embodiment, the robot control system 100 includes a robot 2 and a robot control device 110. In the present embodiment, the robot 2 moves a workpiece 8 from a work start point 6 to a work target point 7. That is, the robot control device 110 controls the robot 2 in such a way as to move the workpiece 8 from the work start point 6 to the work target point 7. The workpiece 8 will also be referred to as a work target. The robot control device 110 controls the robot 2 on the basis of information regarding a space where the robot 2 works. The information regarding the space will also be referred to as spatial information.

### <Robot Control Device 110>

The robot control device 110 obtains a trained model based on learning using training data generated by the data obtaining device 10. The robot control device 110 recognizes, on the basis of images captured by cameras 4 and the trained model, the workpiece 8, or the work start point 6 or the work target point 7, in the space where the robot 2 works. In other words, the robot control device 110 obtains a trained model generated in order to recognize the workpiece 8 or the like on the basis of images captured by the cameras 4.

The robot control device 110 may include at least one processor in order to provide control and processing performance for executing various functions. The components of the robot control device 110 may include at least one processor. Some of the components of the robot control device 110 may be achieved by one processor. The entirety of the robot control device 110 may be achieved by one processor. The processor may execute a program for achieving the various functions of the robot control device 110. The processor may be achieved as a single integrated circuit. The integrated circuit will also be referred to as an IC. The processor may be achieved as a plurality of integrated circuits and discrete circuits communicably connected to one another. The processor may be achieved on the basis of one of various other known techniques.

The robot control device 110 may include a storage. The storage may include an electromagnetic storage medium such as a magnetic disk or may include a memory such as a semiconductor memory or a magnetic memory. The storage stores various types of information and programs and the like to be executed by the robot control device 110. The storage may be a non-transitory readable medium. The storage may function as a work memory of the robot control device 110. At least a part of the storage may be separately configured from the robot control device 110.

### <Robot 2>

The robot 2 may include an arm 2A and an end effector 2B. The arm 2A may be, for example, a six-axis or seven-axis vertical articulated robot. The arm 2A may be a three-axis or four-axis horizontal articulated robot or SCARA robot, instead. The arm 2A may be a two-axis or three-axis Cartesian robot, instead. The arm 2A may be a parallel link robot or the like, instead. The number of axes of the arm 2A is not limited to those described above. In other words, the robot 2 includes the arm 2A connected through a plurality of joints, and moves by driving the joints.

The end effector 2B may include a holding hand capable of holding the workpiece 8. The holding hand may include a plurality of fingers. The number of fingers of the holding hand may be two or more. The fingers of the holding hand may each include one or more joints. The end effector 2B may include a suction hand capable of sucking on the workpiece 8. The end effector 2B may include a scooping hand capable of scooping the workpiece 8. The end effector 2B may include a tool such as a drill, and be capable of drilling a hole in the workpiece 8 and performing various other types of processing. The end effector 2B is not limited to these examples, and may be capable of performing various other operations. In the configuration illustrated in FIG. 17, the end effector 2B includes a holding hand.

The robot control device 110 can control a position of the end effector 2B by operating the arm 2A of the robot 2. The end effector 2B may have an axis that serves as a reference for a direction in which the end effector 2B acts on the workpiece 8. When the end effector 2B has an axis, the robot control device 110 can control a direction of the axis of the end effector 2B by operating the arm 2A of the robot 2. The robot control device 110 controls a start and an end of an operation of the end effector 2B acting on the workpiece 8. The robot control device 110 can move or process the workpiece 8 by controlling the operation of the end effector 2B while controlling the position of the end effector 2B or the direction of the axis of the end effector 2B. In the configuration illustrated in FIG. 17, the robot control device 110 causes the end effector 2B to hold the workpiece 8 at the work start point 6 and moves the end effector 2B to the work target point 7. The robot control device 110 causes the end effector 2B to release the workpiece 8 at the work target point 7. In doing so, the robot control device 110 can move the workpiece 8 from the work start point 6 to the work target point 7 using the robot 2.

### <Sensor 3>

As illustrated in FIG. 17, the robot control system 100 also includes a sensor 3. The sensor 3 detects physical information regarding the robot 2. The physical information regarding the robot 2 may include information regarding an actual position or attitude of each component of the robot 2 or velocity or acceleration of each component of the robot 2. The physical information regarding the robot 2 may include information regarding force acting on each component of the robot 2. The physical information regarding the robot 2 may include information regarding a current flowing to a motor that drives each component of the robot 2 or torque of the motor. The physical information regarding the robot 2 indicates a result of an actual operation of the robot 2. That is, the robot control system 100 can grasp a result of an actual operation of the robot 2 by obtaining the physical information regarding the robot 2.

The sensor 3 may include a force sensor or a tactile sensor that detects force distributed pressure, sliding, or the like acting on the robot 2 as the physical information regarding the robot 2. The sensor 3 may include a motion sensor that detects a position or an attitude, or velocity or acceleration, of the robot 2 as the physical information regarding the robot 2. The sensor 3 may include a current sensor that detects the currents flowing to the motors that drive the robot 2 as the physical information regarding the robot 2. The sensor 3 may include a torque sensor that detects torque of the motors that drive the robot 2 as the physical information regarding the robot 2.

The sensor 3 may be mounted on each joint of the robot 2 or each of joint drivers that drive the joints. The sensor 3 may be mounted on the arm 2A or the end effector 2B of the robot 2.

The sensor 3 outputs the detected physical information regarding the robot 2 to the robot control device 110. The sensor 3 detects and outputs the physical information regarding the robot 2 at certain timing. The sensor 3 outputs the physical information regarding the robot 2 as time-series data.

### <Cameras 4>

In the example of configuration illustrated in FIG. 17, the robot control system 100 includes two cameras 4. The cameras 4 capture images of articles, humans, and the like located inside an effect range 5 in which the operation off the robot 2 can be affected. The images captured by the cameras 4 may include monochromatic luminance information or color luminance information expressed in RGB or the like. The effect range 5 includes an operation range of the robot 2. The effect range 5 is a range obtained by extending the operation range of the robot 2 outward. The effect range 5 may be set such that the robot 2 can be stopped before a human or the like moving from the outside of the operation range of the robot 2 to the inside of the operation range enters the operation range of the robot 2. The effect range 5 may be set as, for example, a range obtained by extending a boundary of the operation range of the robot 2 outward by a certain distance. The cameras 4 may be installed in such a way as to be able to capture images of the effect range 5 or the operation range of the robot 2 or a surrounding area from above. The number of cameras 4 is not limited to two, and may be one, or three or more, instead.

### (Example Operation of Robot Control System 100)

The robot control device 110 obtains a trained model in advance. The robot control device 110 may store the trained model in the storage. The robot control device 110 obtains images of the workpiece 8 from the cameras 4. The robot control device 110 inputs the images of the workpiece 8 to the trained model as input information. The robot control device 110 obtains output information output from the trained model in accordance with the input of the input information. The robot control device 110 recognizes the workpiece 8 on the basis of the output information and performs an operation for holding and moving the workpiece 8.

### Summary

As described above, the robot control system 100 can obtain a trained model based on learning using training data generated by the data obtaining system 1 and recognize the workpiece 8 using the trained model.

Although some embodiments of the data obtaining system 1 and the robot control system 100 have been described above, embodiments of the present disclosure may also include modes of a method or a program for implementing a system or an apparatus and a storage medium (e.g., an optical disc, a magneto-optical disk, a CD-ROM, a CD-R, a CD-RW, a magnetic tape, a hard disk, a memory card, etc.) storing the program.

Implementation modes of the program are not limited to application programs such as object code compiled by a compiler and program code executed by an interpreter, and may be a mode such as a program module incorporated into an operating system, instead. The program may or may not be configured such that a CPU on a control substrate alone performs all processing. The program may be configured such that another processing unit mounted on an expansion board or an expansion unit attached to the substrate performs part or the entirety of the program as necessary.

Although some embodiments of the present disclosure have been described on the basis of the drawings and the examples, note that those skilled in the art can make various variations or alterations on the basis of the present disclosure. Note, therefore, that the scope of the present disclosure includes these variations or alterations. For example, functions included in each component or the like can be rearranged without causing a logical contradiction, and a plurality of components or the like can be combined together or further divided.

All of the components described in the present disclosure and/or all of the disclosed methods or all of the steps in the process may be combined in any manner unless corresponding features are mutually exclusive. Each of the features described in the present disclosure can be replaced by an alternative feature that serves for the same, equivalent, or similar purpose, unless explicitly denied. Each of the disclosed features, therefore, is just an example of a comprehensive series of the same or equivalent features, unless explicitly denied.

The embodiments in the present disclosure are not limited to any specific configuration according to one of the above-described embodiments. The embodiments of the present disclosure can be expanded to all the novel features described in the present disclosure or a combination thereof, all the novel methods or the steps in the process described or a combination thereof.

In an embodiment, (1) a data obtaining device includes a controller capable of controlling a display device including a plurality of pixels, each of which is set to either an ON state or an OFF state, and capable of obtaining a captured image, which is obtained by capturing an image of a target located in front of the display device and the display device. The controller sets a state of each pixel to either the ON state or the OFF state in such a way as to increase a number of ON pixels and decrease a number of ON pixels shown in the captured image or decrease a number of OFF pixels and increase a number of OFF pixels shown in the captured image. The controller generates mask data for the target on a basis of arrangement of the ON pixels.

(2) In the data obtaining device according to (1), the controller may generate the mask data for the target on a basis of the arrangement of the ON pixels at a time when the number of ON pixels is maximum and the number of ON pixels shown in the captured image is minimum or when the number of OFF pixels is minimum and the number of OFF pixels shown in the captured image is maximum.

(3) In the data obtaining device according to (1) or (2), the controller may change a state of a certain pixel. If a part of the captured image corresponding to the certain pixel does not change, the controller may set data indicating that the target is present in a part of the mask data corresponding to the certain pixel. If the part of the captured image corresponding to the certain pixel changes, the controller may set data indicating that the target is absent in the part of the mask data corresponding to the certain pixel.

(4) In the data obtaining device according to (3), the controller may collectively change states of a plurality of pixels as certain pixels.

(5) In the data obtaining device according to (4), the controller may collectively change a state of each of at least a plurality of pixels arranged in a line as the certain pixels.

(6) In the data obtaining device according to (4), the controller may collectively change a state of each of a plurality of pixels included in a certain block as the certain pixels.

(7) In the data obtaining device according to any of (3) to (6), the controller may change the state of the certain pixel by performing expansion or contraction on a basis of arrangement of the ON or OFF pixels.

(8) In the data obtaining device according to any of (1) to (7), the controller may perform calibration for associating a position of each pixel of the display device and a position of each pixel of the captured image with each other.

(9) In the data obtaining device according to any of (1) to (8), the controller may extract, on a basis of the mask data for the target, image data regarding the target from an image of the target captured at a same position as when the captured image has been captured.

(10) In the data obtaining device according to (9), the controller may control illumination light that illuminates the target.

In an embodiment, (11) a data obtaining method includes setting, in a display device including a plurality of pixels, each of which is set to either an ON state or an OFF state, a state of each pixel to either the ON state or the OFF state in such a way as to increase a number of ON pixels and decrease a number of ON pixels shown in a captured image, which is obtained by capturing an image of a target located in front of the display device and the display device, or decrease a number of OFF pixels and increase a number of OFF pixels shown in the captured image and generating mask data for the target on a basis of arrangement of the ON pixels.

(12) The data obtaining method according to (11) may further include extracting, on a basis of the mask data for the target, image data regarding the target from an image of the target captured at a same position as when the captured image has been captured.

In an embodiment, (13) a data obtaining stage includes a display device including a plurality of pixels and a light transmission member located between a target located in front of the display device and the display device.

(14) The data obtaining stage according to (13) may further include a lighting device capable of illuminating the target.

### REFERENCE SIGNS

1 data obtaining system
10 data obtaining device (12: controller, 14: storage, 16: interface)
20 illumination panel (22: OFF range, 24: ON range)
30 image capture device
40 lighting device
50 target
60 captured image (62: target image, 64: extracted image)
70 mask image (72: mask section, 74: transmission section)
80 composite image (82: background image)
100 robot control system (2: robot, 2A: arm, 2B: end effector, 3: sensor, 4: camera,
5: effect range, 6: work start point, 7: work target point, 8: workpiece, 110: robot control device)

1. A data obtaining device comprising:
a controller capable of controlling a display device including a plurality of pixels, each of which is set to either an ON state or an OFF state, and capable of obtaining a captured image, which is obtained by capturing an image of a target located in front of the display device and the display device,
wherein the controller sets a state of each pixel to either the ON state or the OFF state in such a way as to increase a number of ON pixels and decrease a number of ON pixels shown in the captured image or decrease a number of OFF pixels and increase a number of OFF pixels shown in the captured image, and
wherein the controller generates mask data for the target on a basis of arrangement of the ON pixels.

2. The data obtaining device according to claim 1,
wherein the controller generates the mask data for the target on a basis of the arrangement of the ON pixels at a time when the number of ON pixels is maximum and the number of ON pixels shown in the captured image is minimum or when the number of OFF pixels is minimum and the number of OFF pixels shown in the captured image is maximum.

3. The data obtaining device according to claim 1,
wherein the controller changes a state of a certain pixel,
wherein, if a part of the captured image corresponding to the certain pixel does not change, the controller sets data indicating that the target is present in a part of the mask data corresponding to the certain pixel, and
wherein, if the part of the captured image corresponding to the certain pixel changes, the controller sets data indicating that the target is absent in the part of the mask data corresponding to the certain pixel.

4. The data obtaining device according to claim 3,
wherein the controller collectively changes states of a plurality of pixels as certain pixels.

5. The data obtaining device according to claim 4,
wherein the controller collectively changes a state of each of at least a plurality of pixels arranged in a line as the certain pixels.

6. The data obtaining device according to claim 4,
wherein the controller collectively changes a state of each of a plurality of pixels included in a certain block as the certain pixels.

7. The data obtaining device according to claim 3,
wherein the controller changes the state of the certain pixel by performing expansion or contraction on a basis of arrangement of the ON or OFF pixels.

8. The data obtaining device according to claim 1- or 2,
wherein the controller performs calibration for associating a position of each pixel of the display device and a position of each pixel of the captured image with each other.

9. The data obtaining device according to claim 1- or 2,
wherein the controller extracts, on a basis of the mask data for the target, image data regarding the target from an image of the target captured at a same position as when the captured image has been captured.

10. The data obtaining device according to claim 9,
wherein the controller controls illumination light that illuminates the target.

11. A data obtaining method comprising:
setting, in a display device including a plurality of pixels, each of which is set to either an ON state or an OFF state, a state of each pixel to either the ON state or the OFF state in such a way as to increase a number of ON pixels and decrease a number of ON pixels shown in a captured image, which is obtained by capturing an image of a target located in front of the display device and the display device, or decrease a number of OFF pixels and increase a number of OFF pixels shown in the captured image; and
generating mask data for the target on a basis of arrangement of the ON pixels.

12. The data obtaining method according to claim 11, further comprising:
extracting, on a basis of the mask data for the target, image data regarding the target from an image of the target captured at a same position as when the captured image has been captured.

13. A data obtaining stage comprising:
a display device including a plurality of pixels; and
a light transmission member located between a target located in front of the display device and the display device.

14. The data obtaining stage according to claim 13, further comprising:
a lighting device capable of illuminating the target.
